(19) United States
(12) Patent Application Publication
(10) Pub. No.: US 2023/0273962 A1
(43) Pub. Date: Aug. 31, 2023

(54) METHOD AND APPARATUS FOR FINDING ENTERTAINMENT VENUES BASED ON USER INPUT CRITERIA

(71) Applicant: Moultre D. Spencer, Charlotte, NC (US)

(72) Inventor: Moultre D. Spencer, Charlotte, NC (US)

(21) Appl. No.: 17/680,969

(22) Filed: Feb. 25, 2022

(51) Int. Cl. G06F 16/903

(52) U.S. Cl. CPC G06F 16/90335

(57) ABSTRACT

A method and apparatus for allowing users to search for an entertainment venue based on specific criteria. The criteria would include age range, race, gender orientation, type of entertainment, hours of operation, attire, etc. A central server will serve to collect, maintain, and regularly update information related to all entertainment venues in a given geographic area. Users with the inventive application downloaded to an electronic communications device may then search for specific criteria not typically available or regularly updated on entertainment venue websites.

### 1. FIELD OF THE INVENTION

The present invention relates generally to entertainment venues. More particularly, the invention relates to a comprehensive method and associated apparatus to allow users to find entertainment venues based on a variety of user preferences.

### BACKGROUND OF THE INVENTION

Since the advent of the internet, users in search of entertainment venues have used various digital communications devices to search for entertainment venues. The process typically involves a user using, e.g., a smartphone, to search for an entertainment venue. The search is usually focused on the type of entertainment provided, which will often guarantee a certain age demographic. Many entertainment venues have websites listing either the upcoming performances, or the “type” of venue such as a bar, nightclub, dance club etc. The information available on the various websites is varied, transient, and may or may not contain any information regarding the demographics of the attendees.

Also, by design, entertainment venue websites do not list patron demographics as this might tend to deter patrons that assume the clientele of the venue would not be acceptable when this may not be the case. For example, for some venues the demographics would be variable depending upon the type of entertainment, a common situation. Thus, it would be desirable to provide a method and apparatus for allowing a user to search for entertainment venues based on several criteria not typically available on venue websites or any other third party website.

### SUMMARY OF THE INVENTION

A method and apparatus for allowing users to search for an entertainment venue based on specific criteria. The criteria would include age range, race, gender orientation, type of entertainment, hours of operation, attire, etc. A central server will serve to collect, maintain, and regularly update information related to all entertainment venues in a given geographic area. Users with the inventive application downloaded to an electronic communications device may then search for specific criteria not typically available or regularly updated on entertainment venue websites.

It is a major object of the invention to provide an improved method and apparatus for searching for entertainment venues.

It is another object of the invention to provide an improved method and apparatus for searching for entertainment venues based on varied and specific criteria.

It is another object of the invention to provide an improved method and apparatus for searching for entertainment venues based on demographic data related to venue patrons.

It is another object of the invention to provide an improved method and apparatus for searching for entertainment venues based on gender orientation of venue patrons.

It is another object of the invention to provide an improved method and apparatus for searching for entertainment venues based on regularly updated information.

### BRIEF DESCRIPTION OF THE DRAWINGS

FIG. 1 shows a diagrammatic illustration of the method and apparatus of the invention.

### DETAILED DESCRIPTION

The present invention is directed to a method and apparatus which allows a user to search for entertainment venues based on varied and specific criteria. The apparatus includes a central server and a number of user communications devices with a compatible software application.

As used herein “Communications device” is defined as any computer (e.g. desktop, laptop, and/or tablet), phone, smartphone, virtual reality (VR) device, augmented reality (AR) device, personal digital assistant (PDA), or computing device that comprises a battery, display, circuit board, and processor capable of processing or executing software.

A graphic user interface (“GUI”) allows users to interact with communications devices through icons and other visual indicators presented on a display.

A “smartphone” (or “smart phone”) is a mobile telephone with more advanced computing capability and connectivity than basic feature phones. Smartphones typically include the features of a telephone combined with one or more features of other popular consumer devices, for example including but not limited to a personal digital assistant, media player, digital camera, and/or a GPS navigation unit. Smartphones typically include features such as a touchscreen interface, web browsing, broadband network radio (e.g. LTE), Wi-Fi, and 3rd-party apps.

“User” refers to individuals accessing the system solely for the purpose of browsing, selecting, and accessing content available on the system.

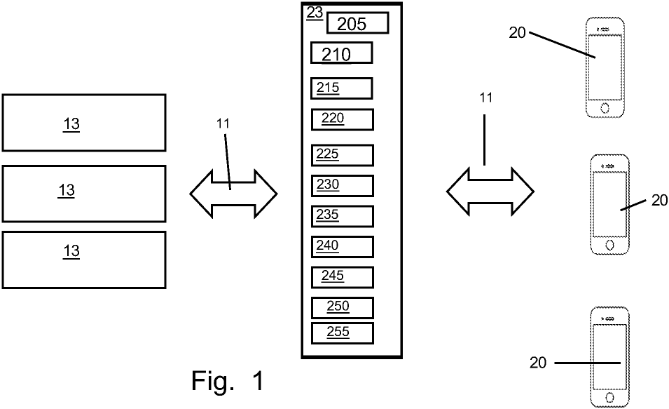

Referring now to FIG. 1, the method and apparatus of the invention, generally indicated by the numeral 10, is diagrammatically illustrated. The method 10 is implemented using the internet 11 to allow for communication between the various users 12, a central server 23, and entertainment venues 13. The central server 23 can be accessed by users and entertainment venues 13 alike via the internet 11 in the well known manner. Data regarding the user accessible search criteria would be compiled, digitized, and organized for storage on the server 23. The invention has particular utility in the fact that entertainment venues do not typically devote much time and effort on their websites as their services cannot typically be purchased on the internet. Also, venues typically want the public to patronize their business regardless of, e.g., race or age demographics, since a patron is likely to spend some money once they have ventured to the location. Even the venues that do maintain informative and updated websites do not include all of the information that a user may wish to know before patronizing the venue. This criteria includes, but is not limited to age, race, and gender orientation of patrons, type of entertainment, updated daily hours of operation (which can change unexpectedly due to, e.g., weather), expected attire, whether there is a dance floor, amenities such as bar food or a hookah lounge, etc.

In order to gather the information, the inventive method requires staff to research and obtain information related to the specific criteria. This process is greatly aided by allowing user input, with at least some users designated as trusted users to provide reliable information as will be described in more detail below. The staff will upload the information to server 23, with preferably real-time or daily updates.

FIG. 1 illustrates an exemplary system 10 for providing searchable criteria related to entertainment venues on a client device. The system 10 includes a communication network 11 (e.g., internet protocol (IP) network, a local area network (LAN), internet, wireless network, such as a Wi-Fi network, and/or the like), a venue management server 23, and client devices 20. A client device 20 may be a communication device as described above. The venue management server 23 manages information associated with various entertainment venues 13, which venues may or may not have websites. In accordance with the method, there is staff associated with server 23 responsible for gathering, verifying, and updating information related to venues 13 in a given geographic area to create a starting database of known specific criteria. The event venue management server 23 may receive information associated with particular events at venues from the client devices 20 and as explained further below. Information obtained from client devices 20 would have to be vetted for accuracy by staff associated with server 23, with some users and client devices 20 being designated as trusted. Regardless of the source, all information relevant to the specified criteria concerning venues 13 would have to be checked for accuracy.

Although FIG. 1 illustrates a single communication network 11, the system 10 can include a plurality of communication networks and/or the plurality of communication networks can be configured in a plurality of ways (e.g., a plurality of interconnected local area networks (LAN), a plurality of interconnected wide area network (WAN), a plurality of interconnected LANs and/or WANs, a plurality of interconnected Wi-Fi networks, etc.). Although FIG. 1 illustrates a single server 23 and client devices 20, the system can include any number of management servers, and/or client devices.

Application software on server 23 can be downloaded from server 23 to client devices 20 via the internet, the software allowing for user authentication and log in so that the user can navigate using GUI driven menus through a sequence of screens to perform the search for the specific venue criteria stored on server 23, this done in the well known manner.

FIG. 1 illustrates an exemplary event management server 23. The event management server 23 includes a communication module 205, a user authentication module 210, a location detection module 215, a nightly event module 220, an account management module 225, an event management module 230, a criteria verification module 235, an output device 240, an input device 245, a processor 250, and a storage device 255. The modules and/or devices can be hardware and/or software. The modules and/or devices illustrated in the venue management server 23 can, for example, utilize the processor 250 to execute computer executable instructions and/or include a processor to execute computer executable instructions (e.g., an encryption processing unit, a field programmable gate array processing unit, etc.). It should be understood that the server 23 can include, for example, other modules, devices, and/or processors known in the art and/or varieties of the illustrated modules, devices, and/or processors. It should be understood that the modules and/or devices illustrated in the event management server 23 can be located within the server 23 and/or connected to the event management server 23 (e.g., directly, indirectly, etc.), but outside of the physical components of the server 23 (e.g., personal computer, mobile device, etc.).

The communication module 205 communicates data to/from the venue management server 23. The user authentication module 210 authenticates users to the venue management server 23. The location detection module 215 may determine geographic location of users’ client devices 20. Based on the geographic location of a client device 20, the location detection module 215 may determine which venues are within a predetermined driving or walking range, so as to limit search in the known manner. The event check-in module 220 manages checking (currently or previously logged in) users into various venues, the checking in process simply involving using geo-spatial data to ensure that the user is actually attending the venue at the time the information regarding the venue is being sent to the servers 23. Only checked in users may send information to the server 23 regarding the specific criteria as stated above, with some users being designated as trusted to indicate that the information is reliable. Staff associated with server 23 can review uploaded information regarding a specific event at a venue, as well as information regarding the venue in general. Staff associated with server 23 would be designated as “trusted” so that information related to any of the specific criteria at any venue would be automatically entered. The event check-in module 220 constantly monitors geo-spatial data associated with client devices 20 and may determine whether a client device 20 is at a live event and may poll the user for instantaneous information regarding the event, venue, or both. By verifying that a user and client device 20 are actually checked in and at the event, the method greatly reduces the possibility of internet trolls or “bots” uploading false or misleading information. Once a user is verified on location at the venue he can become a trusted user with respect to any information uploaded to the server 23, for so long as they remain at the venue. The account management module 225 manages user accounts associated with various client devices 20. It is a key aspect of the invention that only trusted users can enter data regarding the specific criteria at any venue. Also, the inventive method relies on third parties, relative to the venue, to obtain information regarding the venues, this limiting the possibility of personnel related to the venue uploading false or misleading information. With respect to the inventive method, the third parties are staff or users that become trusted users in the manner described herein.

The event management module 230 manages and/or processes information associated with various events at local venues. The event management module 230 is configured to process information associated with events at the local venues. Initial data such as amenities, attire, etc. are obtained and processed by the server 23 as described above. The event management module 230 can process information uploaded from trusted devices 20 with real time information about the event including any change in the specific criteria.

A criteria verification module 235 can be used to verify any information obtained from users via devices 20. The module 235 may only consider information verified if reported by multiple users (at least 2) or if entered by staff having special access to server 23.

The output device 240 outputs information and/or data associated with the server 23 (e.g., information to a printer (not shown), information to a speaker, etc.). The input device 245 receives information associated with the server 23 (e.g., instructions from a user, instructions from a computing device, etc.) from a user (not shown) and/or a computing system (not shown). The input device 245 can include, for example, a keyboard, a scanner, and/or the like.

The processor 250 executes the operating system and/or any other computer executable instructions for the server 23 (e.g., executes applications, etc.). The server 23 can include random access memory (not shown). The random access memory can temporarily store the operating system, the instructions, and/or any other data associated with the management server. The random access memory can include one or more levels of memory storage (e.g., processor register, storage disk cache, main memory, etc.).

The storage device 255 stores (but is not limited to) user account information, information related to various events, information regarding one or more venues 23 including pre-determined venue coordinates, access information, an operating system and/or any other data or program code associated with the server 23. The storage device 255 can include a plurality of storage devices. The storage device 255 can include, for example, long-term storage (e.g., a hard drive, a tape storage device, flash memory, etc.), short-term storage (e.g., a random access memory, a graphics memory, etc.), and/or any other type of computer readable storage.

In operation, a user would access server 23 using device 20 to download the application software necessary to access the data relating to the venue specific criteria stored on server 23 in the above described manner. Once the user has become a member and logged in, they may begin searching using their devices 20 for a venue using a specific criteria such as age or race demographics. The user may also, once logged in and at the venue, provide information related to the specific criteria as discussed above.

I claim:

1. A method of allowing users to search for entertainment venues using a communications device over a distributed network based on specific criteria comprising the steps of:
providing a central server connected to said network, said central server capable of transmitting, receiving, and storing data related to said specific criteria;
downloading application software to one or more user devices, said software allowing for communication between said server and said one or more user devices to allow for authentication and logging in of said user devices;
obtaining and maintaining a database of venue specific criteria on said server, said venue specific criteria including criteria obtained and verified by parties unrelated to said venues.

2. The method of claim 1 wherein said user devices are smartphones.

3. The method of claim 1 wherein said one of said specific criteria is age range.

4. The method of claim 1 wherein said one of said specific criteria is race.

5. The method of claim 1 wherein said one of said specific criteria is gender orientation.

6. The method of claim 1 wherein said one of said specific criteria is type of entertainment.

7. The method of claim 1 wherein said one of said specific criteria is hours of operation.

8. The method of claim 7 wherein data related to said hours of operation is updated in real time.

9. The method of claim 1 wherein said one of said specific criteria is attire.

10. The method of claim 1 including the step of logging in one or more of said user devices to produce one or more logged in user devices, each of said one or more logged in user device in real time communications with said server, said server using geo-positional data from each of said one or more user devices to determine location of said user devices.

11. The method of claim 11 wherein geo-positional data from each of said venues is stored on said server, and wherein venue specific geo-positional data is used to determine when said user devices are positioned at one of said venues, including the step of classifying user devices as trusted devices when positioned at one of said venues.

12. The method of claim 11 wherein only trusted devices are allowed to upload information regarding said specific criteria.
